(19) United States
(12) Patent Application Publication
(10) Pub. No.: US 2020/0090347 A1
(43) Pub. Date: Mar. 19, 2020

(54) APPARATUS FOR ESTIMATING MOVEMENT INFORMATION

(71) Applicant: DENSO TEN Limited, Kobe-shi (JP)

(72) Inventors: Takayuki OZASA, Kobe-shi (JP); Kohji OHNISHI, Kobe-shi (JP); Naoshi KAKITA, Kobe-shi (JP); Teruhiko KAMIBAYASHI, Kobe-shi (JP)

(73) Assignee: DENSO TEN Limited, Kobe-shi (JP)

(21) Appl. No.: 16/557,004

(22) Filed: Aug. 30, 2019

(30) Foreign Application Priority Data
Sep. 13, 2018 (JP) 2018-171539
Oct. 10, 2018 (JP) 2018-191566
Aug. 6, 2019 (JP) 2019-144530

(51) Int. Cl. G06T 7/246; G06T 7/269; H04N 17/00; G06K 9/00; G06T 7/80; H04N 5/225; G05D 1/00

(52) U.S. Cl. CPC G06T 7/248; G06T 7/269; H04N 17/002; G06K 9/00791; G06T 2207/30252; H04N 5/2253; G05D 1/0088; G06T 2207/20004; G06T 2207/20072; G06T 7/80

(57) ABSTRACT

An apparatus for calculating an estimation value of movement information of a mobile body based on information from a camera mounted on the mobile body. The apparatus includes an extractor that extracts feature points from frame images input from the camera, a calculator that calculates an optical flow indicating movements of the feature points between a current frame image and a previous frame image, and an estimator that calculates the estimation value based on the optical flow. The estimator switches a calculation method of the estimation value based on at least one of (i) a speed of the mobile body, (ii) a number of the feature points extracted by the extractor, and (iii) feature amounts indicating uniqueness of the feature points.

### BACKGROUND OF THE INVENTION

### Field of the Invention

The invention relates to an apparatus for estimating movement information.

### Description of the Background Art

Conventionally, a camera used for parking assistance, and the like, is mounted on a mobile body, such as a vehicle. Such a camera is mounted in a fixed state on the vehicle before the vehicle is shipped from a factory. However, an in-vehicle camera may deviate from a factory-installed position due to, for example, an unexpected contact, aging, and the like. When an installation position and an angle of the in-vehicle camera deviate, an error occurs in a steering quantity of a steering wheel, and the like, determined using a camera image. Therefore, it is important to detect an installation deviation of the in-vehicle camera.

Japanese published unexamined application No. 2004-338637 discloses a technology that extracts a feature point from image data acquired by a rear camera by an edge extraction method, and the like, calculates a position of the feature point on a ground surface set by an inverse projection transformation and calculates a movement amount of a vehicle based on a movement amount of the position. Furthermore, a technology has been disclosed that determines that there may be a problem with a camera based on a comparison between the calculated movement amount of the vehicle and a vehicle speed, and the like.

An appearance of the feature point may be changed depending on a lightning environment and a movement of the vehicle. In a case where the appearance of the feature point is changed, there is a possibility that the feature point between frame images cannot be appropriately traced. Thus, there is some room for improvement.

### SUMMARY OF THE INVENTION

According to one aspect of the invention, an apparatus for calculating an estimation value of movement information of a mobile body based on information from a camera mounted on the mobile body includes an extractor that extracts feature points from frame images input from the camera, a calculator that calculates an optical flow indicating movements of the feature points between a current frame image and a previous frame image and an estimator that calculates the estimation value based on the optical flow. The estimator switches a calculation method of the estimation value based on at least one of (i) a speed of the mobile body, (ii) a number of the feature points extracted by the extractor, and (iii) feature amounts indicating uniqueness of the feature points.

As a result, it is possible to improve reliability of the movement information estimated based on the information from the camera mounted on the mobile body.

According to another aspect of the invention, an abnormality detection apparatus includes an extractor that extracts feature points from frame images input from the camera, a calculator that calculates an optical flow indicating movements of the feature points between a current frame image and a previous frame image, an estimator that calculates the estimation value based on the optical flow, and a determination part that determines a presence or absence of an abnormality of the camera mounted on the mobile body based on the calculated estimation value. The estimator switches a calculation method of the estimation value based on at least one of (i) a speed of the mobile body, (ii) a number of the feature points extracted by the extractor, and (iii) feature amounts indicating uniqueness of the feature points.

As a result, it is possible to improve reliability of abnormality detection of the camera mounted on the mobile body.

Therefore, an object of the invention is to provide a technology that can improve the reliability of the movement information estimated based on the information from the camera mounted on the mobile body. Another object of the invention is to provide a technology that can improve the reliability of the abnormality detection of the camera mounted on the mobile body.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a block diagram illustrating a configuration of a system for estimating movement information;

FIG. 2 is a flowchart illustrating one example of an estimation process of the movement information;

FIG. 3 illustrates a feature point extraction method;

FIG. 4 illustrates a method of acquiring a first optical flow;

FIG. 5 illustrates a coordinate transformation process;

FIG. 6 is a flowchart illustrating one example of a selection process of a calculation method;

FIG. 7 illustrates one example of a first histogram generated by an estimator;

FIG. 8 illustrates one example of a second histogram generated by the estimator;

FIG. 9 is a block diagram illustrating a configuration of an abnormality detection system;

FIG. 10 is a flowchart illustrating one example of a detection flow of a camera deviation;

FIG. 11 is a flowchart illustrating one example of a deviation determination process;

FIG. 12 is a block diagram illustrating a configuration of a mobile body control system;

FIG. 13 is a flowchart illustrating one example of the detection flow of the camera deviation;

FIG. 14 is a flowchart illustrating one example of a determination process of a presence or absence of the camera deviation in a first process mode;

FIG. 15 is a flowchart illustrating a detailed example of a process of determining whether or not a process result in the first process mode is a predetermined process result;

FIG. 16 is a schematic diagram illustrating a photographic image photographed by a camera whose position is largely deviated; and

FIG. 17 illustrates the first histogram generated based on the photographic image photographed by the camera whose position is largely deviated.

### DESCRIPTION OF THE EMBODIMENTS

An exemplified embodiment of the invention will be described in detail hereinafter with reference to accompanying drawings. A case in which a mobile body to which the invention is applicable is a vehicle will be described as an example, but the mobile body to which the invention is applicable is not limited to the vehicle. The invention may be applicable to, for example, a robot, and the like. The vehicle widely includes a conveyance having wheels, for example, an automobile, a train, an unmanned carrier, or the like.

In the following description, a straight travel direction of the vehicle, which is a direction from a driver's seat toward a steering wheel, is referred to as a “front direction”. A straight travel direction of the vehicle, which is a direction from the steering wheel toward the driver's seat, is referred to as a “back direction”. A direction perpendicular to the straight travel direction of the vehicle and a vertical line, which is a direction from a right side toward a left side of a driver who faces forward, is referred to as a “left direction”. A direction perpendicular to the straight travel direction of the vehicle and the vertical line, which is a direction from the left side toward the right side of the driver who faces forward, is referred to as a “right direction”. The front, back, left and right directions are simply used for explanation and do not limit an actual positional relationship and direction.

### First Embodiment

<1. System for Estimating Movement Information>

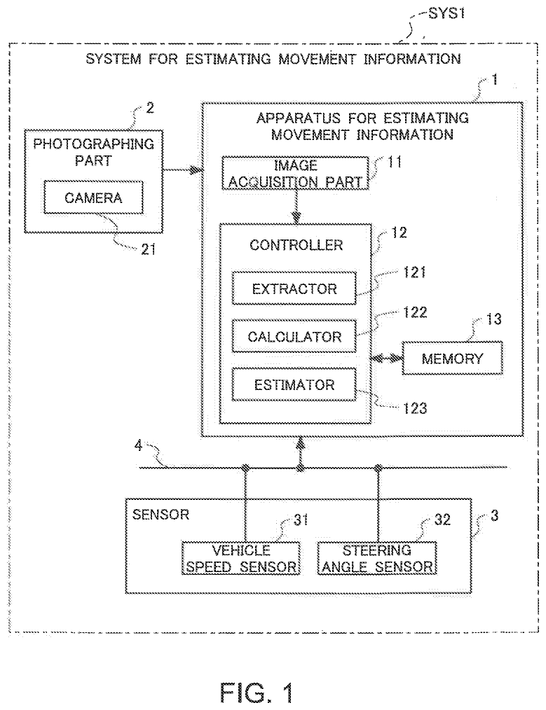

FIG. 1 is a block diagram illustrating a configuration of a system for estimating movement information SYS1. In this embodiment, movement information is a movement distance of the vehicle. However, the movement information of the invention is not limited to the movement distance of the vehicle and, for example, may be a movement speed of the vehicle. As illustrated in FIG. 1, the system for estimating the movement information SYS1 includes an apparatus for estimating movement information 1, a photographing part 2, a sensor 3 and a communication bus 4.

The photographing part 2 is provided on the vehicle to monitor a situation around the vehicle. The photographing part 2 includes a camera 21. That is, the camera 21 is an in-vehicle camera. The camera 21 is configured by using a fish-eye lens. The camera 21 is connected to the apparatus for estimating the movement information 1 via a wireless or wired connection and outputs a photographic image to the apparatus for estimating the movement information 1.

In this embodiment, the camera 21 is a front camera that photographs a front image of the vehicle. However, for example, the camera 21 may photograph a rear image, a left image or a right image of the vehicle. The photographing part 2 may include a plurality of the cameras 21, for example, a rear camera, a left side camera and a right side camera in addition to the front camera. The rear camera photographs a rear image of the vehicle. The left side camera photographs a left side image of the vehicle. The right side camera photographs a right side image of the vehicle.

Based on information from the camera 21 mounted on the vehicle, the apparatus for estimating the movement information 1 calculates an estimation value of the movement information of the vehicle on which the camera 21 is mounted. In this embodiment, the apparatus for estimating the movement information 1 is included in each vehicle on which the camera 21 is mounted. In other words, the apparatus for estimating the movement information 1 is mounted on the vehicle itself for which the estimation value of the movement information is calculated. Hereinafter, the vehicle on which the apparatus for estimating the movement information 1 is mounted may be referred to as a host vehicle.

The apparatus for estimating the movement information 1 may be arranged in a place other than the vehicle for which the estimation value of the movement information is calculated. For example, the apparatus for estimating the movement information 1 may be arranged in a data center communicable with the vehicle having the camera 21, and the like.

The sensor 3 has a plurality of sensors that detect information about the vehicle on which the camera 21 is mounted. In this embodiment, the sensor 3 includes a vehicle speed sensor 31 and a steering angle sensor 32. The vehicle speed sensor 31 detects a speed of the vehicle. The steering angle sensor 32 detects a rotation angle of a steering wheel of the vehicle. The vehicle speed sensor 31 and the steering angle sensor 32 are connected to an abnormality detection apparatus 10 via the communication bus 4. That is, speed information of the vehicle acquired by the vehicle speed sensor 31 is input to the apparatus for estimating the movement information 1 via the communication bus 4. Rotation angle information of the steering wheel of the vehicle acquired by the steering angle sensor 32 is input to the abnormality detection apparatus 10 via the communication bus 4. The communication bus 4 may be a CAN (Controller Area Network) Bus.

<2. Apparatus for Estimating Movement Information>

As illustrated in FIG. 1, the apparatus for estimating the movement information 1 includes an image acquisition part 11, a controller 12 and a memory 13.

The image acquisition part 11 temporally continuously acquires an analog or digital photographic image (frame image) from the camera 21 of the host vehicle in a predetermined cycle (e.g., a cycle of 1/60 second). When the acquired frame image is the analog frame image, the analog frame image is converted into the digital frame image (A/D conversion). The image acquisition part 11 performs a predetermined image process on the acquired frame image and outputs the processed frame image to the controller 12.

The controller 12 is, for example, a microcomputer and integrally controls the entire apparatus for estimating the movement information 1. The controller 12 includes a CPU, a RAM, a ROM, and the like. The memory 13 is, for example, a nonvolatile memory, such as a flash memory and stores various types of information. The memory 13 stores a program as firmware and various types of data.

Specifically, the controller 12 includes an extractor 121, a calculator 122 and an estimator 123. In other words, the apparatus for estimating the movement information 1 includes the extractor 121, the calculator 122 and the estimator 123. Functions of the extractor 121, the calculator 122 and the estimator 123 included in the controller 12 are implemented by the CPU performing arithmetic processing, for example, in accordance with the program stored in the memory 13.

At least any one of the extractor 121, the calculator 122 and the estimator 123 included in the controller 12 may be configured by hardware, such as an ASIC (Application Specific Integrated Circuit) or an FPGA (Field Programmable Gate Array). The extractor 121, the calculator 122 and the estimator 123 included in the controller 12 are conceptual components. The functions performed by one of the components may be distributed to a plurality of components or the functions possessed by a plurality of components may be integrated into one of the components. Functions of the image acquisition part 11 may be implemented by the CPU of the controller 12 performing arithmetic processing in accordance with the program.

The extractor 121 extracts a feature point from the frame image input by the camera 21. The extractor 121 extracts the feature point from each of the acquired frame images. The extractor 121 extracts the feature point from a predetermined region (ROI: Region of Interest) of the frame image. The feature point is a point that can be distinctively detected in the frame image, such as an intersection of edges in the frame image. The feature point is extracted from, for example, a corner of a road surface marking with white lines, etc., cracks, stains and gravels on a road surface, and the like. The feature point may be extracted, for example, by using a known method, such as a Harris operator, or the like.

In this embodiment, the extractor 121 calculates a feature amount for each of picture elements that constitute the frame image and extracts each of the picture elements in which the feature amount exceeds a predetermined threshold value as the feature point. The feature amount is an index indicating uniqueness of the feature point, that is, each of the picture elements has different features from other picture elements. For example, there is a corner's degree that is a degree of corner likeness. In this embodiment, a KLT method (Kanade-Lucus-Tomasi tracker) is used for calculation of the feature amount.

In order to calculate the feature amount, an xy coordinate system is defined on the frame image and the following three parameters are obtained for each of the picture elements using a Sobel filter.

[Formula 1]

G11=dx(x,y)*dx(x,y) (1)

G12=dx(x,y)*dy(x,y) (2)

G22=dy(x,y)*dy(x,y) (3)

wherein G11 is a square value of a differentiation result in an x direction, G12 is a product of the differentiation result in the x direction and a differentiation result in a y direction and G22 is a square value of the differentiation result in the y direction.

By using the Sobel filter, the following matrix M for each of the picture elements is obtained.

$$M = [ \begin{matrix}G 11 & G 12 \\ G 12 & G 22\end{matrix} ] \qquad ( 4 )$$

An eigenvalue λ of the matrix M (equation 4) is obtained from the following equation (5), using I as an identity matrix.

[Formula 3]

det(M−λ1)=0 that is,

λ²−(G11+G22)λ+G11*G22−G12²=0 (5)

A solution of the equation (5) is obtained as λ1 and λ2 shown in the following equations (6) and (7) as a solution of quadratic equation.

$$\begin{matrix}[ Formula 4 ] & \\ λ 1 = \frac{G 11 + G 22}{2} - \sqrt{\frac{{( G 11 - G 22 )}^{2}}{4} + G {12}^{2}} & ( 6 ) \\ λ2 = \frac{G 11 + G 22}{2} + \sqrt{\frac{{( G 11 - G 22 )}^{2}}{4} + G {12}^{2}} & ( 7 )\end{matrix}$$

is extracted as the feature point and the eigenvalue λ1 which is the minimum value is used as the feature amount. In the equation (8), T is a predetermined threshold value for detecting the feature point.

[Formula 5]

min(λ1,λ2)>T (8)

[symbol] between a current frame image and a previous frame image. The previous frame image is a frame image acquired one cycle before the current frame image. The calculator 122 does not calculate the optical flow when there is no previous frame image. The calculator 122 performs a calculation process of the optical flow for each acquired frame image.

The calculator 122 performs a coordinate transformation of the optical flow obtained from the frame image to convert the optical flow into a flow on the road surface (motion vector). In this specification, the flow on the road surface obtained by the coordinate transformation is also included in the optical flow. Hereinafter, the motion vector representing the movement of the feature point on the frame image may be expressed as a first optical flow, and the motion vector representing the movement of the feature point on the road surface may be expressed as a second optical flow. The first optical flow and the second optical flow may be simply expressed as the optical flow without distinction therebetween.

The calculator 122 may first convert each of the feature points extracted from the frame image into coordinates on the road surface and calculate the second optical flow without calculating the first optical flow.

The estimator 123 calculates the estimation value based on the optical flow. In this embodiment, the estimation value is an estimation value of the movement distance of the host vehicle. The estimator 123 switches a calculation method of the estimation value based on a number of the feature points extracted by the extractor 121 and the feature amounts indicating the uniqueness of the feature points. As described above, the feature amounts are calculated by the KLT method. In one aspect of this embodiment, when there is a plurality of the feature points, the estimator 123 switches the calculation method of the estimation value based on the feature amounts of the plurality of the feature points. The calculation method switched by the estimator 123 includes a first calculation method and a second calculation method. The calculation method will be described in detail later.

In this embodiment, the calculation method for calculating the estimation value of movement information is switched based on tendency of the feature points extracted from the frame image. As a result, the estimation value can be obtained by a method suitable for extraction tendency of the feature points and an estimation accuracy of the estimation value can be improved. That is, according to this embodiment, it is possible to improve reliability of the estimation value of the movement information.

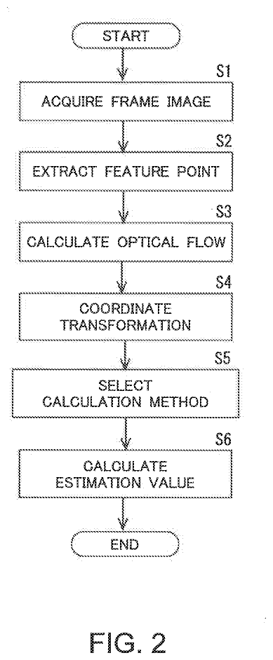

FIG. 2 is a flowchart illustrating one example of an estimation process of the movement information performed by the apparatus for estimating the movement information 1. The estimation process of the movement information is performed, for example, to detect an abnormality of the camera 21 of the host vehicle and to assist parking of the host vehicle. First, the image acquisition part 11 acquires the frame image from the camera 21 of the host vehicle (a step S1). When the frame image has been acquired, the extractor 121 performs an extraction process of the feature points (a step S2).

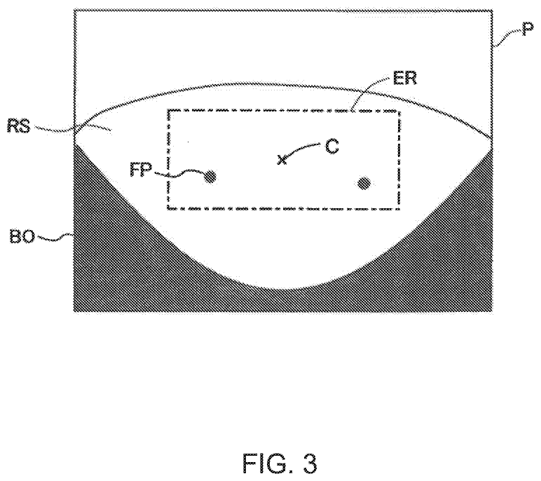

FIG. 3 illustrates a method of extracting feature points FP. FIG. 3 schematically illustrates a frame image P photographed by the camera 21 (front camera). In this embodiment, the feature points FP are extracted from a portion showing a road surface RS of the image. In FIG. 3, a number of the feature points FP is two, but this number is merely for purposes of convenience and does not show an actual number. The feature points FP are often extracted from the road surface RS having many irregularities, for example, an asphalt road surface. On the other hand, a smaller number of the feature points FP are extracted from the road surface RS that is smooth, such as a concrete road surface. When there is a road surface marking with white lines, and the like, on the road surface RS, the feature points FP having large feature amounts are extracted from corners of the road surface markings.

As illustrated in FIG. 3, the extractor 121 extracts the feature points FP from a predetermined extraction range ER of the frame image P. The predetermined extraction range ER is, for example, set in a wide range including a center C of the frame image P. As a result, even when occurrence positions of the feature points FP are not uniform, and the feature points FP are unevenly distributed, the feature points FP can be extracted. The predetermined extraction range ER is set so as to avoid, for example, a range in which a vehicle body BO is reflected.

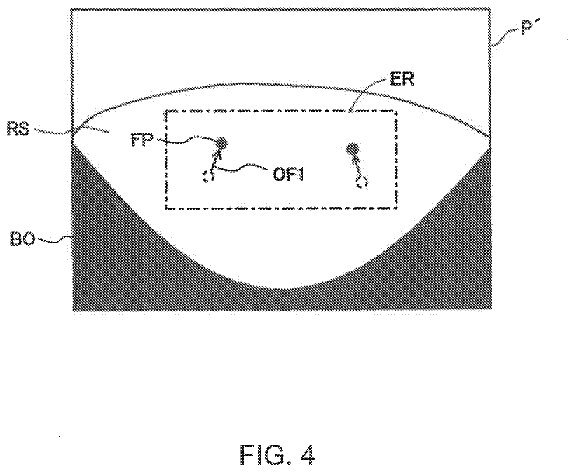

When the feature points FP have been extracted, the calculator 122 calculates the optical flow for each of the extracted feature points FP (a step S3). Specifically, the calculator 122 calculates a first optical flow OF1. FIG. 4 illustrates a method of calculating the first optical flow OF1. FIG. 4 is a schematic diagram illustrated for purposes of convenience in the same manner as FIG. 3. FIG. 4 shows a frame image (current frame image) P′ photographed by the camera 21 after a predetermined cycle has elapsed, after photographing the frame image (previous frame image) P shown in FIG. 3. The host vehicle travels backward before a predetermined time elapses, after photographing the frame image P shown in FIG. 3. Circles with dashed lines shown in FIG. 4 indicate positions of the feature points FP extracted from the previous frame image P shown in FIG. 3.

As illustrated in FIG. 4, when the host vehicle travels backward, the feature points FP in front of the host vehicle move away from the host vehicle. That is, the feature points FP appear at different positions in the current frame image P′ and the previous frame image P. The calculator 122 associates the feature points FP of the current frame image P′ with the feature points FP of the previous frame image P in consideration of values of the picture elements near the feature points FP and calculates the first optical flow OF1 based on respective positions of the associated feature points FP.

When the first optical flow OF1 of each of the feature points FP has been obtained, the calculator 122 performs a coordinate transformation converting each of the first optical flows OF1 obtained in a camera coordinate system into a world coordinate system (a step S4). The second optical flow is obtained by this coordinate transformation.

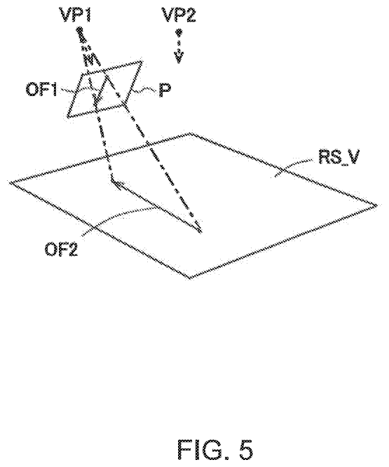

FIG. 5 illustrates a coordinate transformation process. As illustrated in FIG. 5, the calculator 122 converts the first optical flow OF1 viewed from a position of the camera 21 (viewpoint VP1) into a motion vector V viewed from a viewpoint VP2 above the road surface RS on which the host vehicle exists. By projecting each of the first optical flows OF1 on the frame image onto a virtual plane surface RS_V corresponding to the road surface, the calculator 122 converts the first optical flow OF1 into the motion vector V in the world coordinate system. The motion vector V is a motion vector on the road surface RS and a size of the motion vector V indicates a movement amount (movement distance) on the road surface RS. In this embodiment, since the camera 21 has a fish-eye lens, the coordinate transformation includes a distortion correction.

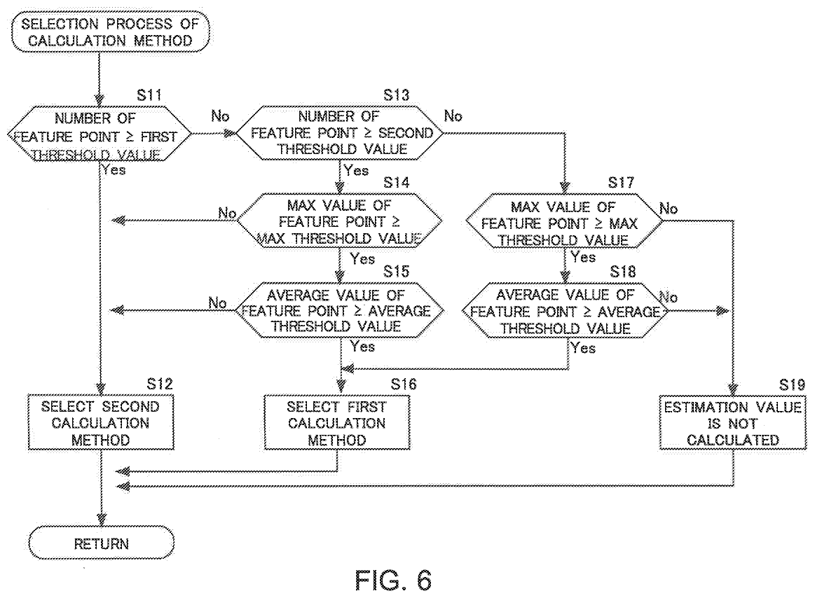

When the motion vector V has been acquired, the estimator 123 selects the calculation method for calculating the estimation value of the movement information (a step S5). FIG. 6 is a flowchart illustrating one example of a selection process of the calculation method to be performed by the estimator 123. The process shown in FIG. 6 is a detailed process example of the step S5 shown in FIG. 2.

In the selection process of the calculation method, the estimator 123 first determines whether or not the number of the feature points FP is equal to or larger than a first predetermined threshold value (a step S11). When a large number of the feature points FP are obtained, a statistical process can be performed using a large number of the optical flows and the estimation value of the movement distance of the host vehicle can be accurately obtained. The number of the feature points FP capable of accurately calculating the estimation value by using the statistical process is, for example, obtained by experiments, simulations, or the like, and the first threshold value is determined based on the obtained number of the feature points FP. In this embodiment, the first threshold value is a value larger than a lower limit value of the number of the feature points FP capable of accurately calculating the estimation value by using the statistical process.

When the number of the feature points FP is equal to or larger than the first threshold value (Yes in the step S11), the estimator 123 determines that the estimation value is calculated by the second calculation method (a step S12). The second calculation method is a method in which the optical flow is obtained for each of the plurality of the feature points extracted by the extractor 121 and the estimation value is calculated by the statistical process using a histogram. It is possible to perform the statistical process using the large number of the optical flows and to accurately calculate the estimation value of the movement distance of the host vehicle. The second calculation method will be described in detail later.

On the other hand, when the number of the feature points FP is smaller than the first threshold value (No in the step S11), the estimator 123 determines whether or not the number of the feature points FP is equal to or larger than a second predetermined threshold value (a step S13). In this embodiment, the second threshold value is a value near the lower limit value of the number of the feature points FP capable of accurately calculating the estimation value by using the statistical process. The second threshold value is, for example, obtained by experiments, simulations, or the like.

When the number of the feature points FP is equal to or larger than the second threshold value (Yes in the step S13), the estimator 123 determines whether or not a maximum value of the feature amounts of the extracted feature points FP is equal to or larger than a predetermined maximum threshold value (a step S14). At a time of this process, there is a plurality of the extracted feature points FP. The largest feature amount among the feature amounts of the plurality of the feature points FP is the maximum value of the feature amounts here. For example, white line corners have very large feature amounts, and the feature points FP thereof are accurately traced. By using such feature points having large feature amounts, it is possible to accurately calculate the optical flow and to improve the estimation accuracy of the estimation value of the movement information. The maximum threshold value is, for example, set to a value capable of determining whether or not there are feature points having very large feature amounts, for example, such as white line corners. The maximum threshold value is, for example, obtained by experiments, simulations, or the like.

When the maximum value of the feature amounts is equal to or larger than the maximum threshold value (Yes in the step S14), the estimator 123 determines whether or not an average value of the feature amounts of the extracted feature points FP is equal to or larger than a predetermined average threshold value (a step S15). At a time of this process, there is a plurality of the extracted feature points FP, and the average value of the feature amounts of the plurality of the feature points FP is obtained. Even when there are feature points FP whose feature amounts are equal to or larger than the maximum threshold value, it is not always determined that the feature points FP are really reliable. Therefore, in this embodiment, it is confirmed whether or not the average value of the feature amounts is equal to or larger than the predetermined average threshold value, and reliability of the feature points FP having feature amounts equal to or larger than the maximum threshold value is determined according to a confirmation result thereof. The average threshold value is, for example, obtained by experiments, simulations, or the like.

When the average value of the feature amounts is equal to or larger than the average threshold value (Yes in the step S15), the estimator 123 determines that the estimation value is calculated by the first calculation method (a step S16). The first calculation method is a method of calculating the estimation value based on the optical flow to be calculated from the feature points FP whose feature amounts are equal to or larger than a predetermined threshold value. The predetermined threshold value here is the maximum threshold value in this embodiment. However, the predetermined threshold value may be different from the maximum threshold value. When the average value of the feature amounts is equal to or larger than the average threshold value, there are a large number of the feature points FP having large feature amounts, and the feature points FP whose feature amounts are equal to or larger than the maximum threshold value are, for example, likely to be white line corners, or the like. As a result, it is possible to improve the reliability of the estimation value of the movement information by calculating the estimation value focused on the optical flow that is obtained from the feature points FP having large feature amounts.

On the other hand, when the maximum value of the feature amounts is smaller than the maximum threshold value (No in the step S14), and the average value of the feature amounts is smaller than the average threshold value (No in the step S15), the estimator 123 determines that the estimation value is calculated by the second calculation method (a step S1). When the maximum value of the feature amounts is smaller than the maximum threshold value, there are no reliable feature points FP, such as white line corners, and it is determined that more reliable estimation value can be calculated by using the statistical process. Therefore, the second calculation method is selected. When the average value of the feature amounts is smaller than the average threshold value, a large number of the extracted feature points FP is estimated to be derived from irregularities of the road surface, etc., in some cases, the feature points FP whose feature amounts are equal to or larger than the maximum threshold value are not necessarily reliable. As a result, it is determined that more reliable estimation value can be calculated by using the statistical process, and the second calculation method is selected.

When the number of the feature points FP is smaller than the second threshold value (No in the step S13), the estimator 123 determines whether or not the maximum value of the feature amounts of the extracted feature points FP is equal to or larger than the predetermined maximum threshold value (a step S17). When there is one feature point FP, the feature amount of the one feature point FP is the maximum value. When there is a plurality of the feature points FP, the largest feature amount among the feature amounts of the plurality of the feature points FP is the maximum value.

When the maximum value of the feature amounts is equal to or larger than the maximum threshold value (Yes in the step S17), the estimator 123 determines whether or not the average value of the feature amounts of the extracted feature points FP is equal to or larger than the predetermined average threshold value (a step S18). When there is one feature point FP, the feature amount of the one feature point FP is the average value. When there is a plurality of the feature points FP, the average value of the feature amounts of the plurality of the feature points FP is obtained.

When the average value of the feature amounts is equal to or larger than the average threshold value (Yes in the step 18), the estimator 123 determines that the estimation value is calculated by the first calculation method (a step S16). This is because that there are reliable feature points FP, such as white line corners, in the extracted feature points FP, and it is determined that the estimation value can be accurately calculated using the optical flow of the feature points FP.

On the other hand, when the maximum value of the feature amounts is smaller than the maximum threshold value (No in the step S17), and the average value of the feature amounts is smaller than the average threshold value (No in the step S18), the estimator 123 selects not to calculate the estimation value (a step S19). Since there are a small number of the extracted feature points FP, and there are no reliable feature points FP, such as while lines corners, it is determined that no reliable estimation value is calculated.

As described above, in this embodiment, the estimator 123 switches the calculation method for calculating the estimation value of the movement information based on the number of the feature points FP, the maximum value of the feature amounts and the average value of the feature amounts. Thus, the estimation value can be calculated by selecting the calculation method by which the estimation accuracy of the estimation value of the movement information is improved. That is, it is possible to improve the reliability of the estimation value of the movement information.

The selection process of the calculation method shown in FIG. 6 is merely an example. For example, the estimator 123 may be configured to switch the calculation method for calculating the estimation value based on only the number of the feature points FP and the maximum value of the feature amounts. That is, in FIG. 6, it may be configured that the step S15 and the step S19 are omitted. Furthermore, for example, when there are feature points FP in which the maximum value of the feature amounts is equal to or larger than the predetermined maximum threshold value, the estimator 123 may be configured to calculate the estimation value by the first calculation method, regardless of the number of the feature points FP.

As described above, in this embodiment, the estimator 123 may determine based on the number of the feature points and the feature amounts that the estimation value cannot be used. Specifically, when it is determined based on the number of the feature points and the feature amounts that only an unreliable estimation value can be obtained, the estimator 123 determines that the estimation value cannot be used. Thus, the apparatus for estimating the movement information 1 can indicate only a reliable estimation value and a device that receives information from the apparatus for estimating the movement information 1 can be prevented from making an erroneous determination. When it is determined that the estimation value cannot be used, information about the feature points FP of the frame should be preferably destroyed. In such a case, the process itself of calculating the estimation value is not preferably performed in terms of processing costs.

Referring back to FIG. 2, when the calculation method has been selected, the estimator 123 calculates the estimation value (a step S6). When the second calculation method has been selected, the estimator 123 generates the histogram based on a plurality of the motion vectors V. In this embodiment, the estimator 123 divides each of the plurality of the motion vectors V into two types of components (i.e., one type is a front-rear direction component and the other type is a left-right direction component) to generate a first histogram and a second histogram. The estimator 123 calculates the estimation value using the first histogram and the second histogram.

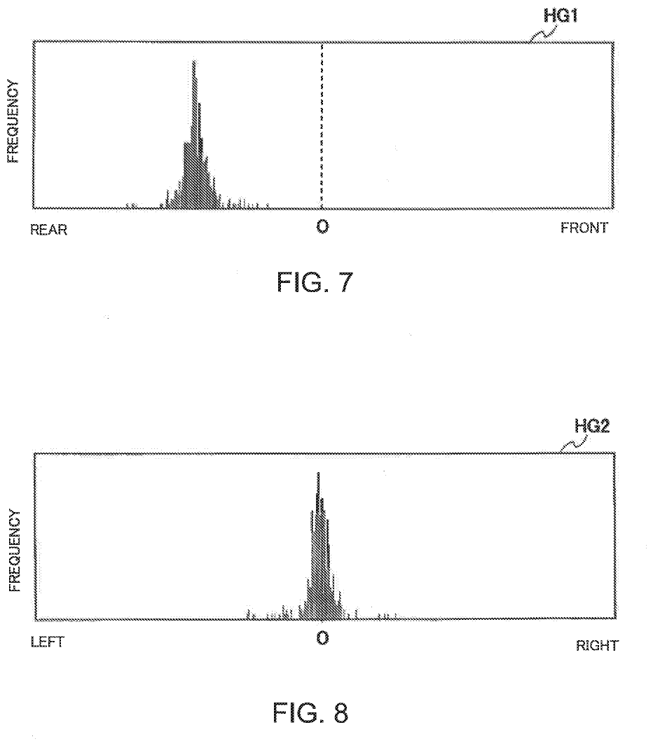

FIG. 7 illustrates one example of a first histogram HG1 generated by the estimator 123. FIG. 8 illustrates one example of a second histogram HG2 generated by the estimator 123. The estimator 123 may perform a removal process of removing the optical flow corresponding to predetermined conditions from all of the optical flows obtained earlier, before and after generation of the histograms HG1 and HG2. In this case, the estimation value of the movement information is obtained using the histograms HG1 and HG2 in which the optical flow is removed by the removal process. For example, the optical flow showing sizes and directions not expected from a speed, a steering angle, a shift lever position, etc. of the host vehicle may be removed. For example, in the histograms, the optical flow belonging to a class whose frequency is extremely low may be removed.

The first histogram HG1 shown in FIG. 7 is a histogram obtained based on the front-rear direction component of each of the motion vectors V. The first histogram HG1 is a histogram in which a number of the motion vectors V is a frequency and the movement distance in a front-rear direction (a length of the front-rear direction component of each of the motion vectors V) is a class. The second histogram HG2 shown in FIG. 8 is a histogram obtained based on the left-right direction component of each of the motion vectors V. The second histogram HG2 is a histogram in which the number of the motion vectors V is a frequency and the movement distance in a left-right direction (a length of the left-right direction component of each of the motion vectors V) is a class.

FIG. 7 and FIG. 8 illustrate histograms obtained when the host vehicle travels straight backward. The first histogram HG1 has a normal distribution shape in which the frequency increases unevenly toward a specific movement distance (class) on a rear side. On the other hand, the second histogram HG2 has a normal distribution shape in which the frequency increases unevenly toward the class near the movement distance of zero.

In this embodiment, the estimator 123 uses a central value (median) of the first histogram HG1 as the estimation value of the movement distance in the front-rear direction. The estimator 123 uses a central value of the second histogram HG2 as the estimation value of the movement distance in the left-right direction. However, a determination method of the estimation value by the estimator 123 is not limited thereto. The estimator 123 may use, for example, the movement distance (the most frequent value) of the class in which the frequency of each of the histogram HG1 and the histogram HG2 is the maximum value as the estimation value. When the central value is used as the estimation value, the central value is preferably obtained after an abnormal value of the histogram has been removed as a noise. For example, the abnormal value is a value abnormally separated from a center of the histogram and corresponds to the movement distance of the class that exists alone (there are few other classes having a frequency around the value) toward an end of the histogram.

On the other hand, when the first calculation method has been selected, the estimator 123 calculates the estimation value based on the optical flow focused on the feature points FP whose feature amounts are equal to or larger than the maximum threshold value. Specifically, when there is one feature point FP whose feature amount is equal to or larger than the maximum threshold value, a length of the front-rear direction component of the second optical flow obtained from the one feature point FP is used as the estimation value of the movement distance in the front-rear direction. Furthermore, a length of the left-right direction component of the second optical flow is used as the estimation value of the movement distance in the left-right direction. When there is a plurality of the feature points FP whose feature amounts are equal to or larger than the maximum threshold value, for example, an average value of the length of the front-rear direction component of the second optical flow obtained from the plurality of the feature points FP is used as the estimation value of the movement distance in the front-rear direction. Furthermore, an average value of the length of the left-right direction component of each of the second optical flows is used as the estimation value of the movement distance in the left-right direction. However, there is a plurality of the feature points FP whose feature amounts are equal to or larger than the maximum threshold value, the estimation value may be obtained from only the second optical flow obtained from the feature point FP having the largest feature amount.

In this embodiment, the calculation method of the estimation value is selected after the optical flow has been obtained, but this is merely an example. For example, the calculation method of the estimation value may be selected before the optical flow is calculated.

In this embodiment, the estimation values of the movement distances in the front-rear direction and the left-right direction are calculated, but this is merely an example. For example, the estimation value of the movement distance in either the front-rear direction or the left-right direction may be calculated.

In the above, the calculation method is switched based on the number of the feature points and the feature amount, but is not limited thereto. The estimator 123 may switch between the first calculation method and the second calculation method based on a speed of a mobile body acquired by the sensor 3. Specifically, when the speed of the vehicle is larger than a predetermined speed, the estimator 123 calculates the estimation value using the first calculation method. Conversely, when the speed of the vehicle is equal to or less than the predetermined speed, the estimator 123 calculates the estimation value using the second calculation method.

In the first calculation method, the feature points can be traced by using the feature points having very large feature amounts, such as white line corners. Thus, even when the speed of the vehicle is high to a certain extent, temporal changes of positions of the feature points, that is, the estimation value of the movement distance can be accurately obtained.

On the other hand, in the second calculation method, a large number of the feature points having small feature amounts are used. As the speed of the vehicle increases, it becomes difficult to trace the feature points having small feature amounts. Thus, the second calculation method is applicable to when the speed of the vehicle is low. That is, it can be also said that the first calculation method is a method for a high speed travel and the second calculation method is a method for a low speed travel.

<3. Abnormality Detection System>

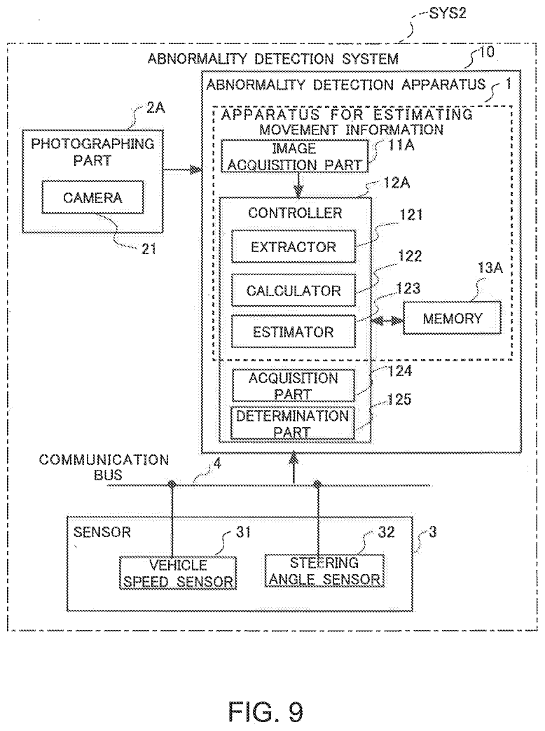

FIG. 9 is a block diagram illustrating a configuration of an abnormality detection system SYS2 according to this embodiment. In this embodiment, an abnormality means a state in which an installation deviation of an in-vehicle camera occurs. That is, the abnormality detection system SYS2 is a system for detecting the installation deviation of the in-vehicle camera (hereinafter, referred to as a “camera deviation”). Specifically, the abnormality detection system SYS2 is, for example, a system for detecting the camera deviation deviated from a reference installation position, such as a factory-installed position of the camera on the vehicle. The camera deviation widely includes an axis deviation, a deviation due to rotation around an axis, and the like. The axis deviation includes a deviation of an installation position, a deviation of an installation angle, and the like.

As illustrated in FIG. 9, the abnormality detection system SYS2 includes the abnormality detection apparatus 10, a photographing part 2A and the sensor 3. The photographing part 2A has a same configuration as the photographing part 2 of the system for estimating movement information SYS1 described above and includes the camera 21. Descriptions of the photographing part 2A and the sensor 3 that are similar to those of the system for estimating movement information SYS1 will be omitted.

The abnormality detection apparatus 10 detects the abnormality of the camera 21 mounted on the vehicle. Specifically, the abnormality detection apparatus. 10 detects the camera deviation of the camera 21 itself based on the information from the camera 21 mounted on the vehicle. By using the abnormality detection apparatus 10, it is possible to rapidly detect the camera deviation. For example, it is possible to prevent driving assistance, etc. from being performed in a state in which the camera deviation has occurred.

In this embodiment, the abnormality detection apparatus 10 is mounted on the vehicle itself for which detection of the camera deviation is performed. However, the abnormality detection apparatus 10 may be arranged in a place other than the vehicle for which the detection of the camera deviation is performed. For example, the abnormality detection apparatus 10 may be arranged in a data center, etc., communicable with the vehicle having the camera 21. When the photographing part 2A has a plurality of the cameras 21, the abnormality detection apparatus 10 detects the camera deviation for each of the plurality of the cameras 21. The abnormality detection apparatus 10 will be described in detail later.

The abnormality detection apparatus 10 may output processing information to a display and a driving assistance device, and the like, which are not shown. The display may display a warning about the camera deviation, etc. on a screen appropriately based on information output from the abnormality detection apparatus 10. The driving assistance device may appropriately stop a driving assistance function based on the information output from the abnormality detection apparatus 10 or may correct photographic information by the camera 21 and perform driving assistance. The driving assistance device may be, for example, an autonomous driving assistance device, an automatic parking assistance device, an emergency brake assistance device, and the like.

<4. Abnormality Detection Apparatus>

As illustrated in FIG. 9, the abnormality detection apparatus 10 includes an image acquisition part 11A, a controller 12A and a memory 13A. Descriptions of the image acquisition part 11A and the memory 13A that are similar to those of the apparatus for estimating the movement information 1 will be omitted.

The controller 12A is, for example, a microcomputer and integrally controls the entire abnormality detection apparatus 10. The controller 12A includes a CPU, a RAM, a ROM, and the like. The controller 12A includes the extractor 121, the calculator 122 and the estimator 123, an acquisition part 124 and a determination part 125. Functions of the extractor 121, the calculator 122, the estimator 123, the acquisition part 124 and the determination part 125 included in the controller 12A are implemented by the CPU performing arithmetic processing, for example, in accordance with the program stored in the memory 13A.

Configurations of the extractor 121, the calculator 122 and the estimator 123 are similar to those of the extractor 121, the calculator 122 and the estimator 123 of the apparatus for estimating the movement information 1. That is, the abnormality detection apparatus 10 is configured to include the apparatus for estimating the movement information 1. The abnormality detection apparatus 10 includes the apparatus for estimating the movement information 1, the acquisition part 124 and the determination part 125.

In the same manner as in the apparatus for estimating the movement information 1, at least any one of the extractor 121, the calculator 122, the estimator 123, the acquisition part 124 and the determination part 125 included in the controller 12A may be configured by hardware, such as an ASIC or an FPGA. The extractor 121, the calculator 122, the estimator 123, the acquisition part 124 and the determination part 125 included in the controller 12A are conceptual components. The function performed by one of the components may be distributed to a plurality of components or the functions possessed by a plurality of components may be integrated into one of the components.

The acquisition part 124 is provided to acquire a comparison value used for comparison with the estimation value acquired by the estimator 123. In this embodiment, the acquisition part 124 acquires the comparison value based on information obtained from a sensor other than the camera 21 that is provided in the host vehicle. Specifically, the acquisition part 124 acquires the comparison value based on information obtained from the sensor 3.

In this embodiment, since the estimation value is a numerical value that represents the movement distance, the comparison value used for comparing with the estimation value is also a numerical value that represents the movement distance. The acquisition part 124 calculates the movement distance by multiplying the vehicle speed obtained from the vehicle speed sensor 31 by a predetermined time. For example, when the estimation value is compared with the comparison value on a one-to-one basis, the predetermined time is the same as a sampling interval (the predetermined cycle described above) of two frame images used for calculating the optical flow. Since there are two types of estimation values (i.e., one type is an estimation value in a forward direction and the other type is an estimation value in a left-right direction), the acquisition part 124 acquires a comparison value in the forward direction and a comparison value in the left-right direction. Travel direction information of the host vehicle can be acquired by information from the steering angle sensor 32. According to this embodiment, it is possible to detect the camera deviation by using a sensor normally included in the host vehicle. Thus, it is possible to reduce equipment cost required for detecting the camera deviation.

When the estimation value is a numerical value that represents the movement speed instead of the movement distance, the comparison value is also a numerical value that represents the movement speed. The acquisition part 124 may acquire the comparison value based on information acquired from, for example, a GPS (Global Positioning System) receiver instead of the vehicle speed sensor 31. The acquisition part 124 may acquire the comparison value based on information obtained from at least one camera other than the camera 21 for which the detection of the camera deviation is performed. In this case, the acquisition part 124 may acquire the comparison value based on the optical flow obtained from a camera other than the camera for which the detection of the camera deviation is performed. That is, a method of acquiring the comparison value is similar to a method of acquiring the estimation value by the apparatus for estimating the movement information 1.

The determination part 125 determines a presence or absence of the abnormality of the camera 21 based on the estimation value obtained by the estimator 123. Specifically, the determination part 125 determines the presence or absence of the abnormality of the camera 21 based on the estimation value obtained by the estimator 123 and the comparison value acquired by the acquisition part 124. For example, the determination part 125 compares the estimation value with the comparison value on a one-to-one basis for each frame image to determine a presence or absence of the camera deviation. In this case, the comparison value acquired by the acquisition part 124 is a correct value of the movement distance of the host vehicle and a size of a deviation of the estimation value relative to the correct value is determined. When the size of the deviation exceeds a predetermined threshold value, the determination part 125 determines that the camera deviation has occurred.

The determination part 125 may determine the presence or absence of the camera deviation at a time at which the estimation values of a predetermined number of the frame images are accumulated, not for each frame image. For example, the determination part 125 accumulates the estimation values for a predetermined number of frames to calculate an accumulated estimation value. Furthermore, the determination part 125 acquires an accumulated comparison value corresponding to a plurality of the frames used for calculating the accumulated estimation value by information from the acquisition part 124. The determination part 125 compares the accumulated estimation value with the accumulated comparison value to determine the presence or absence of the camera deviation.

In this embodiment, since the estimator 123 changes the calculation method according to tendency of the feature points FP to calculate the estimation value, the estimator 123 can accurately calculate the estimation value. Thus, it is possible to improve reliability of a determination result of the camera deviation obtained by comparison between the estimation value and the comparison value. That is, the abnormality detection apparatus 10 according to this embodiment can improve reliability of abnormality detection of the camera 21.

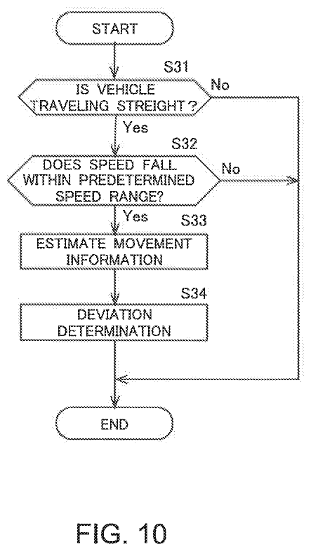

FIG. 10 is a flowchart illustrating one example of a detection flow of the camera deviation by the abnormality detection apparatus 10. The abnormality detection apparatus 10 invokes the detection flow shown in FIG. 10 at predetermined time intervals and performs a detection process of the camera deviation.

The detection process of the camera deviation may be, for example, performed for each predetermined period (for each one-week period, etc.), for each predetermined travel distance (for each 100 km, etc.), for each starting of an engine (for each ignition (IG) on), for each time at which a number of times of starting the engine reaches a predetermined number of times, and the like. In such a case, the abnormality detection apparatus 10 may continue to perform the detection flow shown in FIG. 10 at predetermined time intervals until the detection of the camera deviation succeeds, for example, after the IG on.

As illustrated in FIG. 10, the controller 12A first monitors whether or not the host vehicle on which the camera 21 is mounted is traveling straight (a step S31). When the host vehicle is not traveling straight (No in the step S31), the controller 12A determines that the camera deviation cannot be determined and ends the process. A determination whether or not the host vehicle is traveling straight can be made, for example, based on the rotation angle information of the steering wheel obtained from the steering angle sensor 32. For example, assuming that the host vehicle travels completely straight when the rotation angle of the steering wheel is zero, not only when the rotation angle is zero, but also within a certain range in positive and negative directions, it may be determined that the host vehicle is traveling straight. Traveling straight means traveling straight in both forward and backward directions.

In other words, the controller 12A does not advance a process for determining the presence or absence of the camera deviation unless the host vehicle travels straight. Thus, since the presence or absence of the camera deviation is not determined using information obtained when a travel direction of the host vehicle is curved, information processing for determining the presence or absence of the camera deviation is prevented from becoming complex.

When it is determined that the host vehicle is traveling straight (Yes in the step S31), the controller 12A confirms whether or not a speed of the host vehicle falls within a predetermined speed range (a step S32). The predetermined speed range may be, for example, between 3 km/h and 5 km/h. In this embodiment, the speed of the host vehicle can be acquired by the vehicle speed sensor 31. The order of the step S31 and the step S32 may be reversed.

When the speed of the host vehicle falls outside the predetermined speed range (No in the step S32), the controller 12A determines that the camera deviation cannot be determined and ends the process. That is, unless the speed of the host vehicle falls within the predetermined speed range, the controller 12A does not advance the process for determining the presence or absence of the camera deviation. For example, when the speed of the host vehicle is too high, an error easily occurs when calculating the optical flow. On the other hand, when the speed of the host vehicle is too low, reliability of the speed of the host vehicle acquired from the vehicle speed sensor 31 is lowered. At this point, according to the configuration of this embodiment, the camera deviation can be determined unless the speed of the host vehicle is too high or too low, and a determination accuracy of the presence or absence of the camera deviation is improved.

When it is determined that the host vehicle is traveling within the predetermined speed range (Yes in the step S32), the controller 12A calculates the estimation value of the movement information of the host vehicle by the extractor 121, the calculator 122 and the estimator 123 (a step S33). Description of the process that is similar to a process of estimating the movement information shown in FIG. 2 will be omitted.

When the estimation value of the movement information of the host vehicle has been obtained by the estimator 123, the determination part 125 compares the estimation value with the comparison value acquired by the acquisition part 124 to determine a deviation of the camera 21 (a step S34). In this embodiment, the determination part 125 compares the estimation value with the comparison value in terms of the movement distance in the front-rear direction. Furthermore, the determination part 125 compares the estimation value with the comparison value in terms of the movement distance in the left-right direction. The camera deviation is determined based on a comparison result thereof.

In this embodiment, the deviation is determined based on information obtained when the host vehicle is traveling straight forward or backward. As a result, the comparison value (movement distance) in the left-right direction acquired by the acquisition part 124 becomes zero. The acquisition part 124 calculates the comparison value (movement distance) in the front-rear direction by a photographic time interval between two photographic images for deriving the optical flow and the speed of the host vehicle obtained by the vehicle speed sensor 31 at the time interval.

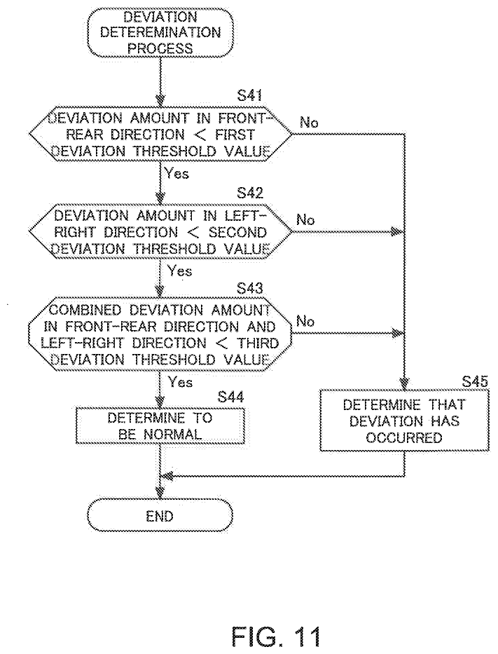

FIG. 11 is a flowchart illustrating one example of a deviation determination process performed by the determination part 125. The process shown in FIG. 11 is a detailed process example of the step S34 in FIG. 10.

First, the determination part 125 confirms whether or not a size (deviation amount in the front-rear direction) of a difference between the estimation value obtained by the estimator 123 and the comparison value acquired by the acquisition part 124 is smaller than a first deviation threshold value in terms of the movement distance in the front-rear direction of the host vehicle (a step S41). When the deviation amount in the front-rear direction is equal to or larger than the first deviation threshold value (No in the step S41), the determination part 125 determines that the camera deviation has occurred (a step S45). That is, the determination part 125 detects the abnormality of the camera 21 in an installation state.

On the other hand, when the deviation amount in the front-rear direction is smaller than the first deviation threshold value (Yes in the step S41), the determination part 125 confirms whether or not a size (deviation amount in the left-right direction) of a difference between the estimation value obtained by the estimator 123 and the comparison value acquired by the acquisition part 124 is smaller than a second deviation threshold value in terms of the movement distance in the left-right direction of the host vehicle (a step S42). When the deviation amount in the left-right direction is equal to or larger than the second deviation threshold value (No in the step S42), the determination part 125 determines that the camera deviation has occurred (the step S45). That is, the determination part 125 detects the abnormality of the camera 21 in the installation state.

On the other hand, when the deviation amount in the left-right direction is smaller than the second deviation threshold value (Yes in the step S42), the determination part 125 confirms whether or not a size (combined deviation amount in the front-rear direction and the left-right direction) of a difference between a value obtained from the estimation value and a value obtained from the comparison value is smaller than a third deviation threshold value in terms of a specific value obtained based on the movement distances in the front-rear direction and the left-right direction of the host vehicle (a step S43). In this embodiment, the specific value is a square root value of a sum of a value obtained by squaring the movement distance in the front-rear direction and a value obtained by squaring the movement distance in the left-right direction. However, this is merely an example and the specific value may be, for example, the sum of the value obtained by squaring the movement distance in the front-rear direction and the value obtained by squaring the movement distance in the left-right direction.

When the combined deviation amount in the front-rear direction and the left-right direction is equal to or larger than the third deviation threshold value (No in the step S43), the determination part 125 determines that the camera deviation has occurred (the step S45). That is, the determination part 125 detects the abnormality of the camera 21 in the installation state. On the other hand, when the combined deviation amount in the front-rear direction and the left-right direction is smaller than the third deviation threshold value (Yes in the step S43), the determination part 125 determines that the installation state of the camera 21 is normal (a step S44). That is, the determination part 125 does not detect the camera deviation.

In this embodiment, if the abnormality is recognized even in any one of the movement distance in the front-rear direction, the movement distance in the left-right direction and the specific value, it is determined that the camera deviation has occurred. Thus, it is possible to reduce a possibility that even though the camera deviation has occurred, it is determined that no camera deviation has occurred. However, this is merely an example. For example, it may be determined that the camera deviation has occurred only when the abnormality is recognized in all of the movement distance in the front-rear direction, the movement distance in the left-right direction and the specific value.

In this embodiment, the movement distance in the front-rear direction, the movement distance in the left-right direction and the specific value are sequentially compared, but the comparison may be performed at the same timing. Furthermore, when the movement distance in the front-rear direction, the movement distance in the left-right direction and the specific value are sequentially compared, the order is not particularly limited, and the comparison may be performed in a different order from that shown in FIG. 11. In this embodiment, a deviation determination is performed using the movement distance in the front-rear direction, the movement distance in the left-right direction and the specific value, but this is merely an example. For example, the deviation determination may be performed using any one or any two of the movement distance in the front-rear direction, the movement distance in the left-right direction and the specific value.

In this embodiment, when the abnormality has been detected by the comparison result using the estimation value obtained from one frame image, the camera deviation is immediately detected. However, this is merely an example, and the determination part 125 may be configured to detect the camera deviation based on the comparison result of a plurality of the frame images.

When the camera deviation has been detected, the abnormality detection apparatus 10 preferably performs a process of notifying a driver, etc. that the camera deviation has occurred.

Furthermore, the abnormality detection apparatus 10 preferably performs a process of notifying a driving assistance device which performs driving assistance using information from the camera 21 that the camera deviation has occurred. When the plurality of the cameras 21 is mounted on the host vehicle, if the camera deviation has occurred in at least one of the plurality of the cameras 21, the process of notifying the driver, the driving assistance device, etc. is preferably performed.

In the above, data used for the abnormality detection of the camera 21 is collected when the host vehicle is traveling straight. However, this is merely an example, and the data used for the abnormality detection of the camera 21 may be collected when the host vehicle is not traveling straight. By using the speed information obtained from the vehicle speed sensor 31 and information obtained from the steering angle sensor 32, it is possible to accurately obtain comparison values (movement distance and speed compared to the estimation value) in the front-rear direction and the left-right direction of the host vehicle. Therefore, even when the data collected when the host vehicle is not traveling straight is used, it is possible to detect the abnormality of the camera.

Furthermore, in the above, a case in which the apparatus for estimating the movement information 1 of the invention is applicable to the abnormality detection apparatus 10 has been described, but this is merely an example. The apparatus for estimating the movement information 1 of the invention may be applicable to, for example, a device that performs driving assistance, such as parking assistance, using an optical flow obtained from a photographic image of a camera.

### Second Embodiment

<1. Mobile Body Control System>

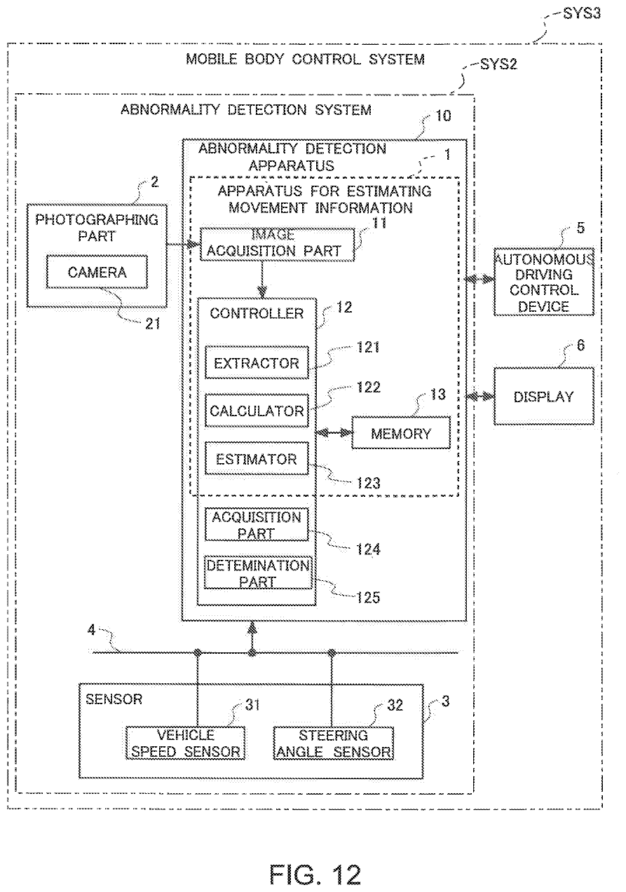

FIG. 12 is a block diagram illustrating a configuration of a mobile body control system SYS3 according to a second embodiment of this invention. In this embodiment, the mobile body is a vehicle and the mobile body control system SYS3 is a vehicle control system. As illustrated in FIG. 12, the mobile body control system SYS3 includes an abnormality detection system SYS2, an autonomous driving control device 5 and a display 6. As described later, the abnormality detection system SYS2 includes an abnormality detection apparatus 10. In other words, the mobile body control system SYS3 includes the abnormality detection apparatus 10 and the autonomous driving control device 5.

The autonomous driving control device 5 controls autonomous driving of the mobile body. The autonomous driving control device 5 is mounted on each mobile body. Specifically, the autonomous driving control device 5 is an ECU (Electric Control Unit) that controls a driving part, a braking part and a steering part of the vehicle. The driving part includes, for example, an engine and a motor. The braking part includes a brake. The steering part includes a steering wheel. An ON/OFF control operation by the autonomous driving control device 5 is switchably provided by an instruction from the abnormality detection apparatus 10. Once the control by the autonomous driving control device 5 has started, operations including acceleration, braking and steering are autonomously performed without a driver's operation. The ON/OFF control operation by the autonomous driving control device 5 can be preferably switched by the driver.

The display 6 is mounted on each mobile body. Specifically, the display 6 is arranged at a position at which a display surface of the display 6 can be seen from the driver inside a vehicle cabin. The display 6 may be, for example, a liquid crystal display, an organic EL display, a plasma display, and the like. The display 6 may be fixed to the vehicle but may be taken out from the vehicle.

<2. Abnormality Detection System>

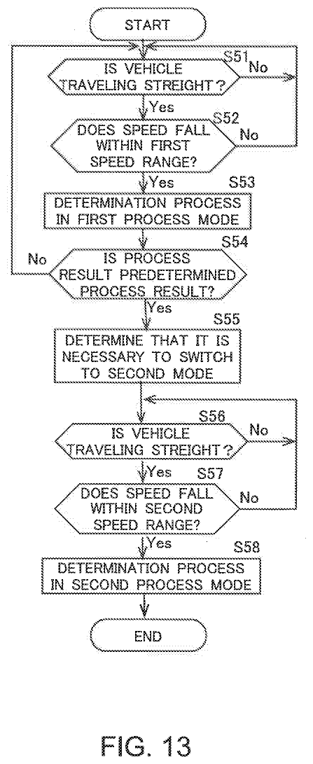

As illustrated in FIG. 13, the abnormality detection system SYS2 includes the abnormality detection apparatus 10, a photographing part 2 and a sensor 3. Descriptions of the photographing part 2 and the sensor 3 that are similar to those of the first embodiment will be omitted

The abnormality detection apparatus 10 detects an abnormality of a camera 21 that is mounted on the mobile body. In this embodiment, the abnormality detection apparatus 10 is connected to the autonomous' driving control device 5 and the display 6 through a wired or wireless connection and exchanges information with the autonomous driving control device 5 and display 6. The abnormality detection apparatus 10 will be described in detail later.

<3. Abnormality Detection Apparatus>

As illustrated in FIG. 13, the abnormality detection apparatus 10 includes an image acquisition part 11, a controller 12 and a memory 13. Description of the abnormality detection apparatus 10 that is similar to that of the first embodiment will be omitted.

In this embodiment, the controller 12 calculates an estimation value of movement information of the mobile body based on a temporal change of a position of a feature point extracted from a photographic image photographed by the camera 21 and determines a presence or absence of the abnormality of the camera 21 based on the calculated movement information. In the determination process, it is possible to switch between a first process mode and a second process mode. That is, there are cases in which the controller 12 determines a presence or absence of a camera deviation according to the first process mode and in which the controller 12 determines the presence or absence of the camera deviation according to the second process mode.

In the first process mode, the estimation value of the movement information is calculated based on a first calculation method. At this time, a threshold value for extracting the feature point is a first threshold value. The estimation value of the movement information is calculated based on a representative value of an optical flow calculated for the extracted feature point.

In the second process mode, the estimation value of the movement information is calculated based on the second calculated method. At this time, a threshold value for extracting the feature point is a second threshold value smaller than the first threshold value. The estimation value is calculated by performing a statistical process using a histogram based on the optical flow calculated for the extracted feature point.

In this embodiment, a picture element satisfying the equation (8) is extracted as the feature point. An eigenvalue λ1 which is the minimum value is set to a feature amount. In the equation (8), T is a predetermined threshold value for detecting the feature point. Specifically, the predetermined threshold T is a first threshold value T1 in the first process mode and a second threshold value T2 in the second process mode. The second threshold value T2 is smaller than the first threshold value T1. The first threshold value T1 is set so that only the feature points having very large feature amounts, for example, such as white line corners are extracted. The second threshold value T2 is set so that a large number of the feature points derived from fine irregularities of a road surface are extracted.

The first process mode is used when a speed of the mobile body (vehicle) is higher compared to the second process mode. In the first process mode, the feature points can be traced by using the feature points having very large feature amounts, such as white line corners. Thus, even when the speed of the vehicle is high to a certain extent, the temporal changes of the positions of the feature points can be accurately obtained, and a determination accuracy of the presence or absence of the camera deviation is prevented from being lowered. On the other hand, in the second process mode, a large number of the feature points having small feature amounts are used. As the speed of the vehicle increases, it becomes difficult to trace the feature points having small feature amounts. Thus, the second process mode is applicable to when the speed of the vehicle is low. That is, the first process mode is suitable for a high speed travel and the second process mode is suitable for a low speed travel.

According to the configuration of this embodiment, when the vehicle travels at a high speed, a determination process of the camera deviation is performed in the first process mode. When the vehicle travels at a low speed, the determination process of the camera deviation is performed in the second process mode. That is, the camera deviation can be determined by a method suitable for a traveling speed, and erroneous detection of the camera deviation can be reduced.

In this embodiment, specifically, the first process mode is a process mode used at a normal time. The second process mode is a process mode used when a predetermined process result is obtained in the first process mode. That is, the abnormality detection apparatus 10, in principle, determines the presence or absence of the camera deviation in the first process mode using information obtained from the vehicle that travels at a high speed. The abnormality detection apparatus 10 exceptionally switches from the first process mode to the second process mode only on specific conditions and determines the presence or absence of the camera deviation using information obtained from the vehicle that travels at a low speed. According to this embodiment, a process related to detection of the camera deviation is prevented from being performed during the low speed travel and a process not related to the detection of the camera deviation can be performed during the low speed travel.

In this embodiment, the controller 12 is provided to perform a recognition process of recognizing a surrounding environment of the mobile body (vehicle) based on the photographic image photographed by the camera 21. The recognition process is, for example, a process of extracting an edge from a frame image and recognizing moving objects and stationary objects around the vehicle. For example, recognition of moving objects and stationary objects is performed by known pattern matching processing and arithmetic processing using a neural network, and the like. In other words, the controller 12 includes a function other than a function as an apparatus for detecting the abnormality of the camera 21. In this embodiment, the controller 12 includes a function as a device that performs parking assistance.

When the speed of the mobile body (vehicle) is a speed corresponding to the second process mode at the normal time, the controller 12 gives priority to the recognition process of the surrounding environment of the vehicle over the determination process of determining the presence or absence of the abnormality of the camera 21. In this embodiment, at the normal time, the controller 12 gives priority to the recognition process of the surrounding environment of the vehicle during the low speed travel and gives priority to the determination process of determining the presence or absence of the camera deviation during the high speed travel. Thus, it is possible to prevent the processes of the controller 12 from being excessively concentrated for a period of time and reduce a processing load of the controller 12. Since the recognition process of the surrounding environment for parking assistance of the vehicle is performed during the low speed travel, the configuration of this embodiment is preferably employed when the controller 12 also includes a function as the device that performs the parking assistance.

FIG. 13 is a flowchart illustrating one example of a detection flow of the camera deviation by the abnormality detection apparatus 10. A detection process of the camera deviation may be, for example, performed for each predetermined period (for each one-week period, etc.), for each predetermined travel distance (for each 100 km, etc.), for each starting of an engine (for each ignition (IG) on, etc.), for each time at which a number of times of starting the engine reaches a predetermined number of times, and the like. In this embodiment, since the photographing part 2 includes four cameras 21, the detection flow of the camera deviation shown in FIG. 2 is performed for each of the cameras 21. In order to avoid overlapped description, the detection flow of the camera deviation will be described using a case in which one of the cameras 21 is a front camera as a representative example.

As illustrated in FIG. 13, the controller 12 first monitors whether or not the vehicle on which the camera 21 is mounted is traveling straight (a step S51). A determination whether or not the vehicle is traveling straight can be made, for example, based on rotation angle information of a steering wheel obtained from a steering angle sensor 32. Traveling straight means traveling straight in both forward and backward directions.

The controller 12 repeats monitoring of the step S51 until a straight traveling of the vehicle is detected. That is, the controller 12 advances a process related to the camera deviation on a condition that the vehicle is traveling straight. Thus, since the process related to the detection of the camera deviation is performed without using information obtained when a traveling direction of the vehicle is curved, information processing is prevented from becoming complex.

When it is determined that the vehicle is traveling straight (Yes in the step S51), the controller 12 confirms whether or not the speed of the vehicle falls within a first speed range (a step S52). The first speed range may be, for example, between 15 km/h and 30 km/h. In the first speed range, the speed is preferably set to a speed higher than a speed at which the parking assistance of the vehicle is performed. When the speed of the vehicle is too high, it becomes difficult to trace the feature points. Therefore, the speed of the vehicle is preferably not too high.

When the speed of the vehicle falls outside the first speed range (No in the step S52), the controller 12 returns to the step S51. That is, the controller 12 advances the process related to the camera deviation on the condition that the vehicle is traveling straight, and the speed of the vehicle falls within the first speed range. In this embodiment, in principle, the process related to the camera deviation is not started when traveling at a low speed. Thus, it is possible to prevent the recognition process of the surrounding environment of the vehicle and the process related to the camera deviation from being simultaneously advanced and prevent the processing load of the controller 12 from being concentrated at a given time.

When it is determined that the vehicle is traveling within the first speed range (Yes in the step S52), the controller 12 performs the determination process of the presence or absence of the camera deviation in the first process mode (a step S53). The order of the step S51 and the step S52 may be reversed.

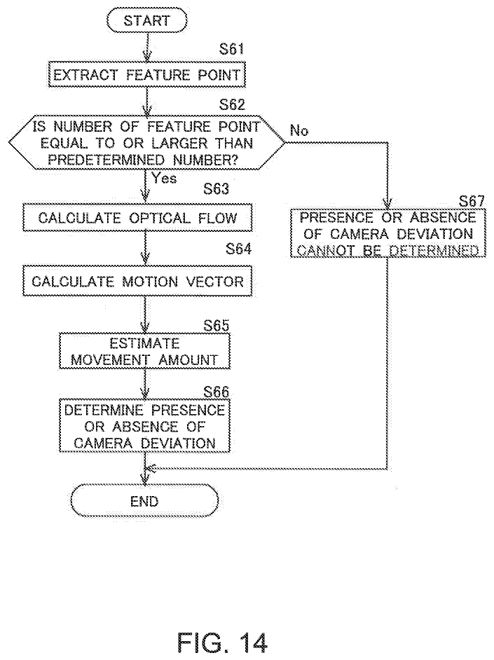

FIG. 14 is a flowchart illustrating one example of the determination process of the presence or absence of the camera deviation in the first process mode. As illustrated in FIG. 14, the controller 12 extracts the feature points having feature amounts exceeding the first threshold value T1 from the frame image (a step S61). In other words, the controller 12 performs subsequent processes for the feature points having the feature amounts exceeding the first threshold value T1. In the first process mode, the first threshold value T1 for extracting the feature points is set to a high value. Thus, the feature points to be extracted are the feature points having large feature amounts showing a corner likeness. Description of the extraction of the feature points that is similar to that of the first embodiment will be omitted.

When the feature points FP have been extracted, it is confirmed whether or not a number of the feature points FP is equal to or larger than a predetermined number (a step S62). When the number of the feature points does not reach the predetermined number (No in the step S62), the controller 12 determines that the presence or absence of the camera deviation cannot be determined (a step S67) and ends the determination process in the first process mode. On the other hand, when the number of the feature points is equal to or larger than the predetermined number (Yes in the step S62), the optical flow indicating movements of the feature points FP between two frame images input at the predetermined time interval is calculated (a step S63). The predetermined number may be one or more and the number may be decided by experiments, simulations, or the like. Description of calculation of the optical flow that is similar to that of the first embodiment will be omitted.

When an optical flow OF1 of the feature points FP has been calculated, the controller 12 calculates a motion vector V (a step S64) by performing a coordinate transformation of the optical flow OF1 given in a camera coordinate system. Description of the coordinate transformation that is similar to that of the first embodiment will be omitted.

When the motion vector V indicating the movement on a road surface RS has been calculated, the controller 12 calculates the estimation value of the movement amount (movement distance) based on the motion vector V (a step S65). The controller 12 calculates the estimation value of the movement amount using the first calculation method.

When the estimation value of the movement amount has been obtained, the controller 12 compares the estimation value with a comparison value obtained by information from the sensor 3 to determine the presence or absence of the camera deviation (a step S66). Description of the determination of the presence or absence of the camera deviation that is similar to that of the first embodiment will be omitted.

Referring back to FIG. 13, when the determination process of the presence or absence of the camera deviation in the first process mode has ended, the controller 12 determines whether or not a process result is a predetermined process result (a step S54). When the process result is the predetermined process result (Yes in the step S54), it is determined that it is necessary to switch from the first process mode to the second process mode and perform the determination process of the presence or absence of the camera deviation (a step S55). On the other hand, when the process result is not the predetermined process result (No in the step S54), the process returns to the step S51 and the controller 12 repeats the processes after the step S51.

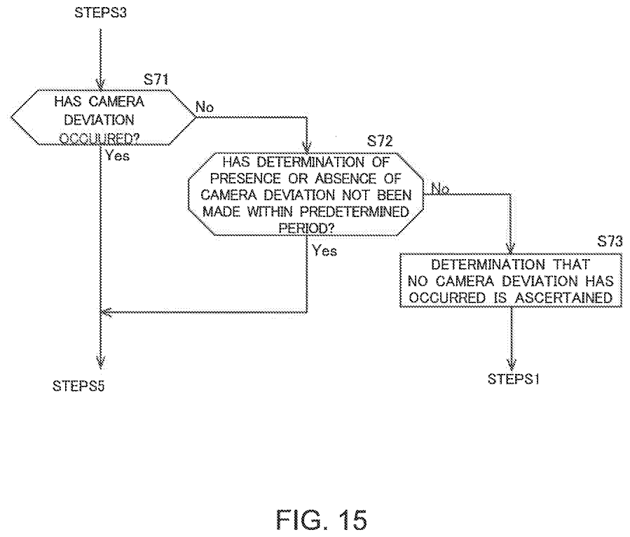

FIG. 15 is a flowchart illustrating a detailed example of a process of determining whether or not the process result in the first process mode is the predetermined process result. FIG. 15 is a flowchart illustrating a detailed example of the step S54 in FIG. 13. As illustrated in FIG. 15, it is confirmed whether or not it has been determined that the camera deviation had occurred by the determination process in the first process mode (a step S71).

When it has been determined that the camera deviation had occurred (Yes in the step S71), the process moves to the step S55 shown in FIG. 13. On the other hand, when it has not been determined that the camera deviation had occurred (No in the step S71), it is confirmed whether or not the determination of the presence or absence of the camera deviation has not been made within a predetermined period (a step S72). In the first process mode, when the determination of the presence or absence of the camera deviation has not been continuously made over a predetermined plurality of the frames, it is determined that the determination of the presence or absence of the camera deviation has not been made within the predetermined period.

When the determination of the presence or absence of the camera deviation has not been made within the predetermined period (Yes in the step S72), the process moves to the step S55 shown in FIG. 13. On the other hand, when the determination of the presence or absence of the camera deviation has been made within the predetermined period (No in the step S72), the determination that no camera deviation has occurred is ascertained (a step S73) and the process is ended.

As described above, in this embodiment, the predetermined process result shown in the step S54 in FIG. 13 includes a process result that there is an abnormality in the camera 21 (the camera deviation has occurred). Thus, when the camera deviation has been recognized in the first process mode performed during the high speed travel, the determination process of the camera deviation in the second process mode performed during the low speed travel is performed. Therefore, it is possible to reduce erroneous detection of the camera deviation.

In this embodiment, the predetermined process result shown in the step S54 in FIG. 13 includes a process result that the presence or absence of the abnormality of the camera 21 (the presence or absence of the camera deviation) has not been determined for the predetermined period. A situation that the number of the feature points FP to be detected does not reach the predetermined number occurs when an installation position of the camera 21 is largely deviated as well as when there are no feature points FP having large feature amounts, such as white line corners. This difference cannot be clearly distinguished only in the first process mode. As in this embodiment, when a situation that the presence or absence of the camera deviation cannot be determined is repeated, the determination process in the second mode in which the threshold value for extracting the feature points FP is lowered is performed. Thus, it is possible to appropriately detect the camera deviation.

Referring back to FIG. 13, when the second process mode is performed in the step S55 and subsequent steps, the controller 12 gives priority to the determination process of the abnormality of the camera 21 (camera deviation) over the recognition process of the surrounding environment of the vehicle using the camera 21. Thus, when the vehicle is traveling at a low speed, only when there is a possibility that the camera deviation has occurred, the determination process of the camera deviation is given priority over the recognition process of the surrounding environment. Therefore, it is possible to appropriately detect the abnormality of the camera 21 while giving priority to the process (recognition process of the surrounding environment) for the purpose of mounting the camera 21 to the vehicle as much as possible.

In this embodiment, when the controller 12 switches from the first process mode to the second process mode, the controller 12 requests the autonomous driving control device 5 to perform autonomous driving. By this request, when a mobile body control system SYS4 performs the determination process of determining the presence or absence of the abnormality of the camera 21 (camera deviation) in the second process mode, the mobile body control system SYS4 allows the mobile body (vehicle) to perform autonomous driving. After it has been determined that the first process mode needs to be switched to the second process mode, the autonomous driving is preferably started at a timing capable of securing safety. This determination may be performed by the autonomous driving control device 5 and the autonomous driving control device 5 notifies the controller 12 of the start of the autonomous driving. For example, the autonomous driving is temporarily performed at a timing of starting or stopping of the vehicle.

According to this embodiment, it is possible to allow the vehicle to travel straight accurately with a constant steering wheel angle while allowing the vehicle to travel at a low speed in a predetermined speed range, and it is possible to accurately perform the determination process of the presence or absence of the camera deviation in the second process mode.

When the autonomous driving for the determination process in the second process mode has been started, it is confirmed whether or not the vehicle is traveling straight in the same manner as in the first process mode (a step S56). When the vehicle is traveling straight (Yes in the step S56), the controller 12 confirms whether or not the speed of the vehicle falls within a second speed range (a step S57). The second speed range may be, for example, between 3 km/h and 5 km/h.

When the speed of the vehicle falls outside the second range (No in the step S57), the controller 12 ends the process. That is, the controller 12 advances the process related to the camera deviation on conditions that the vehicle is traveling straight and the speed of the vehicle falls within the second speed range. When it is determined that the vehicle is traveling within the second speed range (Yes in the step S57), the controller 12 performs the determination process of the presence or absence of the camera deviation in the second process mode (a step S58).

Next, the determination process of the presence or absence of the camera deviation in the second process mode will be described. Description will be made using FIG. 14, as a flow of the determination process in the second process mode is similar to that of the determination process in the first process mode shown in FIG. 14. Detailed descriptions that are similar to those in FIG. 14 will be omitted.

As illustrated in FIG. 14, the controller 12 extracts the feature points FP from the frame image (a step S61). In the second mode, picture elements having feature amounts exceeding the second threshold value T2 are extracted as the feature points FP. In other words, the controller 12 performs the following processes for the feature points having the feature amounts exceeding the second threshold value T2. The second threshold value T2 is set to a value lower than the first threshold value T1 (threshold value in the first process mode). Therefore, a large number of the feature points FP derived from fine irregularities of the road surface are extracted. For example, a large number of the feature points FP are extracted from the road surface having many irregularities, for example, an asphalt road surface.

When the feature points FP have been extracted, it is confirmed whether or not a number of the feature points FP is equal to or larger than the predetermined number (a step S62). When the number of the feature points does not reach the predetermined number (No in the step S62), the controller 12 determines that the presence or absence of the camera deviation cannot be determined (a step S67) and ends the determination process in the first process mode.

For example, on a smooth road surface, such as a concrete road surface, the number of the feature points FP tends to decrease. That is, depending on conditions of the road surface, the feature points to be extracted may not be obtained sufficiently. In consideration of such a point, in the second process mode as well as the first process mode, when the number of the feature points does not reach the predetermined number, it is determined that the presence or absence of the camera deviation cannot be determined, and the determination process is performed again.

When the number of the feature points is equal to or larger than the predetermined number (Yes in the step S62), the controller 12 calculates the optical flow OF1 (the step S63). When the optical flow OF1 has been calculated, the controller 12 performs a coordinate transformation of the optical flow OF1 and calculates a motion vector V (the step S64). These processes are similar to those of the first process mode.

When the motion vector V has been calculated, the controller 12 calculates the estimation value of the movement amount using the second calculation method. When the estimation value of the movement amount has been obtained, the controller 12, in the same manner as in the first process mode, compares the estimation value with the comparison value obtained by information from the sensor 3 to determine the presence or absence of the camera deviation (the step S66). In the second process mode, since the movement amount can be estimated by using a large amount of the feature points, it is possible to improve an accuracy of the determination process of the presence or absence of the camera deviation, compared to the first process mode. In the second process mode as well as the first process mode, it may be configured to determine the presence or absence of the camera deviation based on a process result of a plurality of the frame images.

When it has been determined in the second mode the camera deviation had occurred, the abnormality detection apparatus 10 detects the camera deviation. When the camera deviation has been detected, it is preferable that the abnormality detection apparatus 10 performs a process for displaying occurrence of the camera deviation on the display 6 and notifies the driver, etc. of the abnormality of the camera 21. Furthermore, the abnormality detection apparatus 10 preferably performs a process for stopping (turning off) a driving assistance function (for example, an automatic parking function, etc.) using information from the camera 21. At this time, it is preferable to indicate that the driving assistance function has been stopped on the display 6. When a plurality of the cameras 21 are mounted on the vehicle, if the camera deviation has occurred in at least one of the plurality of the cameras 21, the notification process to the driver, etc. and the stopping process of the driving assistance function are preferably performed.

When it has been determined in the second process mode that no camera deviation has occurred, the abnormality detection apparatus 10 determines that no camera deviation has been detected and temporarily ends the detection process of the camera deviation. Then, the detection process of the camera deviation is started again at a predetermined timing.

In this embodiment, normally, the first process mode in which the presence or absence of the camera deviation during the high speed travel is determined is used, and the second mode in which the presence or absence of the camera deviation during the low speed travel is determined is used only when there is a possibility that the camera deviation has occurred in the first process mode. As a result, when traveling at a low speed, in principle, the recognition process of the surrounding environment by the camera 21 can be performed without being disturbed by the detection process of the camera deviation. Furthermore, since the camera deviation can be determined using two process modes, a possibility of erroneous detection of the camera deviation can be reduced.

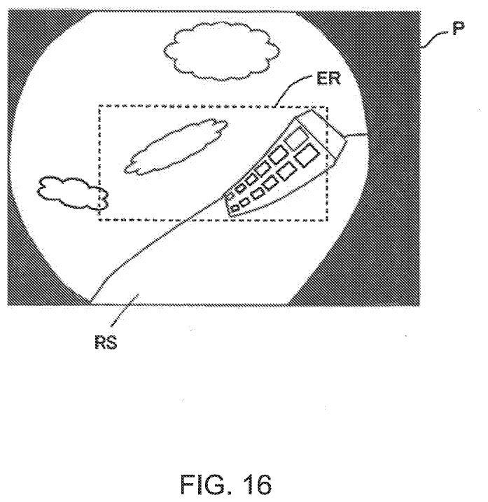

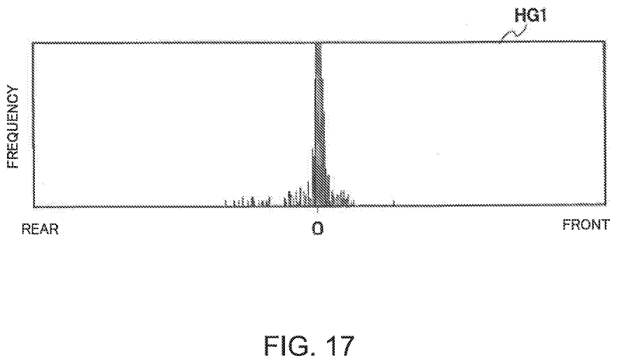

In this embodiment, it can be appropriately detected that the installation position of the camera 21 has been largely deviated. This will be described with reference to FIG. 16 and FIG. 17. FIG. 16 is a schematic diagram illustrating a photographic image P photographed by the camera 21 whose position is largely deviated. FIG. 17 illustrates a first histogram HG1 generated based on the photographic image P photographed by the camera 21 whose position is largely deviated.

In an example shown in FIG. 16, the camera 21 is largely deviated and sky and a distant building (three-dimensional object) are mainly reflected within an extraction range ER of the feature points. Normally, since the feature points FP of the sky and the distant three-dimensional object have small feature amounts, the feature points FP are not extracted as the feature points FP in the first process mode in which a large threshold value is set. That is, when a large camera deviation has occurred, in the first process mode, a situation that the number of the feature points FP to be extracted does not reach the predetermined number and the camera deviation cannot be determined continues for a predetermined period. As a result, the first process mode is switched to the second process mode and the determination process of the camera deviation is performed. In the second process mode, since the threshold value for extracting the feature points FP is decreased, the feature points FP derived from the sky and the distant three-dimensional object are extracted.

As illustrated in FIG. 17, although the vehicle is moving, sizes of the motion vectors V of the feature points FP derived from the sky and the distant three-dimensional object become zero or near zero. This is because the feature points FP derived from the sky and the distant three-dimensional object are located very far from the vehicle. As a result, when a large camera deviation occurs, there is a large difference between the estimation value and the comparison value. Thus, it is possible to detect the camera deviation.

In the above, when the determination process of the presence or absence of the camera deviation is performed in the second process mode, the autonomous driving is performed, but this is merely an example. When the determination process of the presence or absence of the camera deviation is performed in the second process mode, driving by the driver (manual driving) may be performed. In this case, when the controller 12 switches from the first process mode to the second process mode, the controller 12 preferably causes the display 6 that is mounted on the mobile body (vehicle) to display a message prompting the driver to perform driving suitable for the second process mode. Display contents of a display screen may include, for example, that it is necessary to perform the determination process of the camera deviation and what kind of driving is required to perform the determination process. The display process by the display 6 allows the driver to recognize that it is necessary to determine the camera deviation and to start driving according to the determination result. In addition to or instead of the message on the screen, it may be configured to prompt the driver to perform driving suitable for the second process mode, for example, by voice. Furthermore, when the determination process is performed in the first process mode, it may also be configured to display on the display 6 the message prompting the driver to perform driving suitable for the first process mode. In some cases, when the determination process of the presence or absence of the camera deviation is performed in the first process mode, the autonomous driving may be performed.

In the above, the first process mode is used at the normal time and the second process mode is used only when the predetermined process result is obtained in the first process mode, but this is merely an example. The second process mode may be used regardless of the process result in the first process mode. For example, when it is determined by a navigation device, and the like, that a host vehicle is traveling through a place other than a parking area, the detection process of the camera deviation using the second process mode instead of the first process mode may be performed on a condition that the host vehicle is traveling at a low speed (e.g., 3 km/h or more and 5 km/h or less).

In the above, there are two process modes that can be switched and used for the determination process, but a number of the process modes may be three or more.

In the above, data used for abnormality detection of the camera 21 is collected when the host vehicle is traveling straight. However, this is merely an example, and the data used for the abnormality detection of the camera 21 may be collected when the host vehicle is not traveling straight.

In the above, it has been described that various functions are implemented in software by the CPU performing arithmetic processing in accordance with a program, but at least some of the functions may be implemented by an electrical hardware circuit. Conversely, at least some of the functions to be implemented by a hardware circuit may be implemented in software.

While the invention has been shown and described in detail, the foregoing description is in all aspects illustrative and not restrictive. It is therefore understood that numerous other modifications and variations can be devised without departing from the scope of the invention.

What is claimed is:

1. An apparatus for calculating an estimation value of movement information of a mobile body based on information from a camera mounted on the mobile body, the apparatus comprising:
an extractor that extracts feature points from frame images input from the camera;
a calculator that calculates an optical flow indicating movements of the feature points between a current frame image and a previous frame image; and
an estimator that calculates the estimation value based on the optical flow, wherein
the estimator switches a calculation method of the estimation value based on at least one of (i) a speed of the mobile body, (ii) a number of the feature points extracted by the extractor, and (iii) feature amounts indicating uniqueness of the feature points.

2. The apparatus according to claim 1, wherein
the estimator switches the calculation method based on (i) the number of the feature points, (ii) a maximum value of the feature amounts, and (iii) an average value of the feature amounts.

3. The apparatus according to claim 1, wherein
the calculation method includes:
a first calculation method in which the estimation value is calculated based on the feature points whose feature amounts are larger than a first threshold value; and
a second calculation method in which the estimation value is calculated based on the feature points whose feature amounts are smaller than the first threshold value and larger than a second threshold value.

4. The apparatus according to claim 3, wherein
when the speed of the mobile body is higher than a predetermined speed, the estimation value is calculated using the first calculation method, and
when the speed of the mobile body is equal to or lower than the predetermined speed, the estimation value is calculated using the second calculation method.

5. The apparatus according to claim 3, wherein
the first calculation method calculates the estimation value based on a representative value of the optical flow calculated from the feature points, and
the second calculation method calculates the estimation value by performing a statistical process using a histogram based on the optical flow for each of the feature points.

6. The apparatus according to claim 1, wherein
the estimator determines, based on the number of the feature points and the feature amounts, that the estimation value cannot be used.

7. The apparatus according to claim 6, wherein
when the estimator determines that the estimation value cannot be used, the estimation value is not calculated.

8. An abnormality detection apparatus comprising:
the apparatus according to claim 1; and
a determination part that determines a presence or absence of an abnormality of the camera mounted on the mobile body based on the calculated estimation value.

9. An abnormality detection apparatus comprising:
the apparatus according to claim 4; and
a controller that determines a presence or absence of an abnormality of the camera mounted on the mobile body based on the calculated estimation value, wherein
the controller switches between a first process mode in which the presence or absence of the abnormality of the camera is determined based on the estimation value calculated using the first calculation method and a second process mode in which the presence or absence of the abnormality of the camera is determined based on the estimation value calculated using the second calculation method.

10. The abnormality detection apparatus according to claim 9, wherein
the first process mode is a process mode used at a normal time, and
the second process mode is a process mode used when a predetermined process result is obtained in the first process mode.

11. The abnormality detection apparatus according to claim 10, wherein
the predetermined process result includes a process result that there is the abnormality in the camera.

12. The abnormality detection apparatus according to claim 10, wherein
the predetermined process result includes a process result that a presence or absence of the abnormality of the camera has not been determined for a predetermined period.

13. The abnormality detection apparatus according to claim 10, wherein
the controller performs a recognition process of recognizing a surrounding environment of the mobile body based on a photographic image photographed by the camera,
when the speed of the mobile body is lower than a predetermined speed at the normal time, the controller gives priority to the recognition process over the determination process of determining the presence or absence of the abnormality of the camera, and
when the second process mode is performed, the controller gives priority to the determination process over the recognition process.

14. The abnormality detection apparatus according to claim 10, wherein
when the controller switches from the first process mode to the second process mode, the controller causes a display that is mounted on the mobile body to display a message prompting a driver to perform driving suitable for the second process mode.

15. The abnormality detection apparatus according to claim 10, wherein
when the controller switches from the first process mode to the second process mode, the controller requests an autonomous driving control device that controls autonomous driving of the mobile body to perform autonomous driving.

16. A mobile body control system that controls movement of a mobile body, the system comprising:
the abnormality detection apparatus according to claim 9; and
an autonomous driving control device that controls autonomous driving of the mobile body, wherein
at least when the controller performs the determination process of determining the presence or absence of the abnormality of the camera in the second process mode, the mobile body control system allows the mobile body to perform the autonomous driving.

17. A method of calculating an estimation value of movement information of a mobile body based on information from a camera mounted on the mobile body, the method comprising the steps of:
(a) extracting feature points from frame images input from the camera;
(b) calculating an optical flow indicating movements of the feature points between a current frame image and a previous frame image; and
(c) calculating the estimation value based on the optical flow, wherein
the step (c) switches a calculation method of the estimation value based on at least one of (i) a speed of the mobile body, (ii) a number of the feature points extracted by the step (a), and (iii) feature amounts indicating uniqueness of the feature points.

18. An abnormality detection method that detects an abnormality of a camera to be mounted on a mobile body, the method comprising the steps of:
(a) extracting feature points from frame images input from the camera;
(b) calculating an optical flow indicating movements of the feature points between a current frame image and a previous frame image;
(c) calculating an estimation value based on the optical flow; and
(d) determining a presence or absence of the abnormality of the camera, wherein
when a speed of the mobile body is higher than a predetermined speed, the step (c) calculates the estimation value by a first calculation method based on the feature points whose feature amounts are larger than a first threshold value, and
when the speed of the mobile body is equal to or lower than the predetermined speed, the step (c) calculates the estimation value by a second calculation method based on the feature points whose feature amounts are larger than a second threshold value smaller than the first threshold value.
